(19) United States
(12) Patent Application Publication
(10) Pub. No.: US 2024/0175409 A1
(43) Pub. Date: May 30, 2024

(54) INTEGRATED THRUST REVERSER AND BRAKE CONTROL FOR AN AIRCRAFT

(71) Applicant: Raytheon Technologies Corporation, Farmington, CT (US)

(72) Inventors: David Wasselin, Longmeadow, MA (US); Nancy Poisson, Avon, CT (US); Brian V. Winebrenner, Vernon, CT (US); Bradley C. Schafer, Ellington, CT (US); Ramesh Rajagopalan, Glastonbury, CT (US)

(21) Appl. No.: 18/071,141

(22) Filed: Nov. 29, 2022

Related U.S. Application Data
(60) Provisional application No. 63/283,778, filed on Nov. 29, 2021.

(51) Int. Cl. F02K 1/76; B64D 31/09; B64D 45/00; B64D 45/04; B64F 5/60; G05D 1/617; G05D 1/654; G05D 109/22

(52) U.S. Cl. CPC F02K 1/76; B64D 31/09; B64D 45/04; B64F 5/60; G05D 1/617; G05D 1/654; B64D 2045/0085; G05D 2109/22

(57) ABSTRACT

A system of an aircraft includes a thrust reverser control configured to control deployment of one or more thrust reversers of the aircraft, a brake control configured to control operation of one or more brakes of the aircraft, and a controller. The controller is configured to detect a landing condition of the aircraft, determine one or more thrust reverser deployment and brake control parameters for one or more current conditions at a target location of the aircraft, and control the one or more thrust reversers and the one or more brakes upon landing at the target location based on the one or more thrust reverser deployment and brake control parameters. The controller can modify one or more control parameters of the aircraft based on detecting a change in the one or more current conditions at the target location or a fault condition of the aircraft.

### CROSS-REFERENCE TO RELATED APPLICATIONS

This application claims the benefit of U.S. Provisional Application No. 63/283,778 filed Nov. 29, 2021, the disclosure of which is incorporated herein by reference in its entirety.

### BACKGROUND

Exemplary embodiments of the present disclosure pertain to the art of aircraft control and, more particularly, to a method and a system for integrated thrust reverser and brake control of an aircraft.

During landing of an aircraft or during a rejected takeoff, aircraft typically use a combination of thrust reversers and brakes to slow the aircraft. Deployment of thrust reversers and use of brakes are typically pilot and/or co-pilot decisions and actions. The decisions and actions are among the many steps that the pilot and/or co-pilot have to perform along with adjusting throttle settings, control surfaces of the aircraft, and performing communication activities.

### BRIEF DESCRIPTION

Disclosed is a system of an aircraft that includes a thrust reverser control configured to control deployment of one or more thrust reversers of the aircraft, a brake control configured to control operation of one or more brakes of the aircraft, and a controller. The controller is configured to detect a landing condition of the aircraft, determine one or more thrust reverser deployment and brake control parameters for one or more current conditions at a target location of the aircraft, and control the one or more thrust reversers and the one or more brakes upon landing at the target location based on the one or more thrust reverser deployment and brake control parameters. The controller can modify one or more control parameters of the aircraft based on detecting a change in the one or more current conditions at the target location or a fault condition of the aircraft.

In addition to one or more of the features described above or below, or as an alternative, further embodiments may include where the landing condition is detected based on one or more of: an on-ground state indicator, available runway length, runway condition, aircraft weight, weather condition, throttle setting, and speed of the aircraft.

In addition to one or more of the features described above or below, or as an alternative, further embodiments may include where the controller is configured to check an operational and/or health state of the one or more thrust reversers prior to initiating automated control of the one or more thrust reversers.

In addition to one or more of the features described above or below, or as an alternative, further embodiments may include where the controller is configured to command a gas turbine engine associated with the one or more thrust reversers to increase a thrust output while the one or more thrust reversers are deployed and reduce the thrust output based on the speed of the aircraft dropping below a threshold speed.

In addition to one or more of the features described above or below, or as an alternative, further embodiments may include where the controller is configured to stow the one or more thrust reversers after the speed of the aircraft is below the threshold speed.

In addition to one or more of the features described above or below, or as an alternative, further embodiments may include where the controller is configured to limit the thrust output and adjust one or more control surfaces of the aircraft based on detecting a fault with at least one of the one or more thrust reversers.

In addition to one or more of the features described above or below, or as an alternative, further embodiments may include where the one or more current conditions comprise one or more of a runway state, a taxiway state, and weather conditions at the target location, and the controller is configured to determine use of aircraft control surfaces, thrust reverser control, brake control, and engine operation based on a health, state, and the one or more current conditions.

In addition to one or more of the features described above or below, or as an alternative, further embodiments may include where the controller is configured to determine the one or more thrust reverser deployment and brake control parameters based at least in part on a parts life model associated with one or more parts of the aircraft, a landing configuration, and an aircraft state.

In addition to one or more of the features described above or below, or as an alternative, further embodiments may include where the controller is configured to determine the one or more thrust reverser deployment and brake control parameters based at least in part on a corrected runway length at the target location and a corrected aircraft weight.

In addition to one or more of the features described above or below, or as an alternative, further embodiments may include where the controller is configured to control a pressure applied on the one or more brakes.

Also disclosed is a method that includes detecting, by a control system of an aircraft, a landing condition of the aircraft. The control system can determine one or more thrust reverser deployment and brake control parameters for one or more current conditions at a target location of the aircraft. The control system can control the one or more thrust reversers and the one or more brakes upon landing at the target location based on the one or more thrust reverser deployment and brake control parameters. The control system can modify one or more control parameters of the aircraft based on detecting a change in the one or more current conditions at the target location or a fault condition of the aircraft.

In addition to one or more of the features described above or below, or as an alternative, further embodiments may include commanding, by the control system, a gas turbine engine associated with the one or more thrust reversers to increase a thrust output while the one or more thrust reversers are deployed and reduce the thrust output based on the speed of the aircraft dropping below a threshold speed, and stowing the one or more thrust reversers after the speed of the aircraft is below the threshold speed.

In addition to one or more of the features described above or below, or as an alternative, further embodiments may include where the one or more current conditions comprise one or more of a runway state and a taxiway state at the target location, and further including determining the one or more thrust reverser deployment and brake control parameters based at least in part on a parts life model associated with one or more parts of the aircraft, a landing configuration, an aircraft state, a corrected runway length at the target location and a corrected aircraft weight.

In addition to one or more of the features described above or below, or as an alternative, further embodiments may include controlling a pressure applied on the one or more brakes.

Also disclosed is a method that includes detecting, by a control system of an aircraft, a takeoff mode of the aircraft and monitoring for one or more failure conditions of the aircraft. The control system can control one or more thrust reversers and one or more brakes of the aircraft based on detecting that the one or more failure conditions should result in a rejected takeoff. The control system can modify one or more control parameters of the aircraft based on detecting a thrust reverser fault and/or a brake fault during the rejected takeoff.

In addition to one or more of the features described above or below, or as an alternative, further embodiments may include outputting a warning indicator based on detecting that the one or more failure conditions should result in a rejected takeoff.

In addition to one or more of the features described above or below, or as an alternative, further embodiments may include commanding, by the control system, a gas turbine engine associated with the one or more thrust reversers to increase a thrust output while the one or more thrust reversers are deployed and reduce the thrust output based on the speed of the aircraft dropping below a threshold speed.

In addition to one or more of the features described above or below, or as an alternative, further embodiments may include limiting the thrust output and adjusting one or more control surfaces of the aircraft based on detecting a fault with at least one of the one or more thrust reversers.

In addition to one or more of the features described above or below, or as an alternative, further embodiments may include determining the one or more thrust reverser deployment and brake control parameters based at least in part on an aircraft state, a corrected runway length, and a corrected aircraft weight.

### BRIEF DESCRIPTION OF THE DRAWINGS

The following descriptions should not be considered limiting in any way. With reference to the accompanying drawings, like elements are numbered alike:

FIG. 1 is a schematic diagram of an aircraft, in accordance with an embodiment of the disclosure;

FIG. 2 is a schematic diagram of a control system, in accordance with an embodiment of the disclosure;

FIG. 3 is a data flow diagram, in accordance with an embodiment of the disclosure;

FIG. 4 is a flow chart illustrating a method, in accordance with an embodiment of the disclosure; and

FIG. 5 is a flow chart illustrating a method, in accordance with an embodiment of the disclosure.

### DETAILED DESCRIPTION

A detailed description of one or more embodiments of the disclosed apparatus and method are presented herein by way of exemplification and not limitation with reference to the Figures.

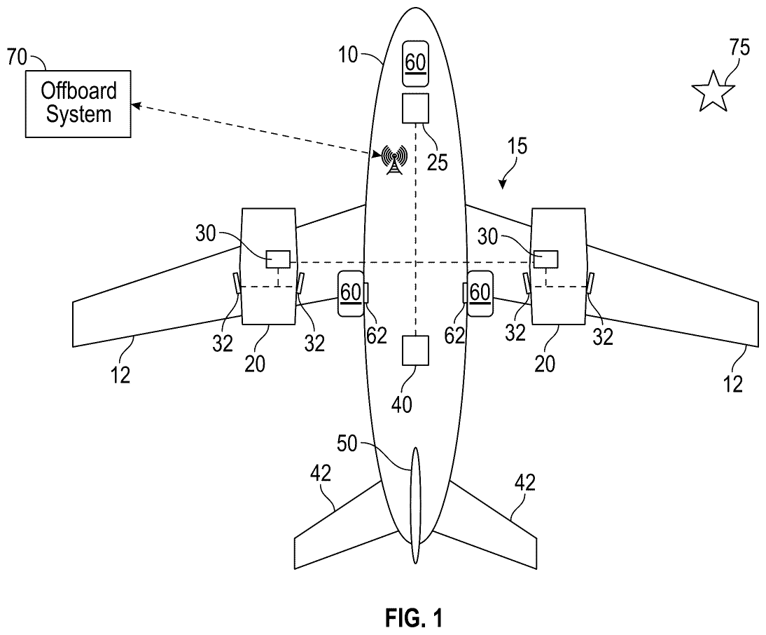

FIG. 1 schematically illustrates an aircraft 10 that includes a pair of gas turbine engines 20 with thrust reversers 32. The thrust reversers 32 can be any type of thrust reverser known in the art, such as cascade reversers, clamshell reversers, and the like. The aircraft 10 also includes wheels 60 and brakes 62 that allow for ground-based movement, steering, and braking of the aircraft 10. Embodiments of the present disclosure control operation of the aircraft 10 to manage deployment of the thrust reversers 32 and use of the brakes 62 to reduce pilot burden and reduce component wear as further described herein. The aircraft 10 also includes a control system 15 that can be distributed throughout the aircraft 10. For example, the control system 15 can include pilot controls 25, controllers 30, and a flight management system 40. The controllers 30 can be located in close proximity to the thrust reversers 32, such as integrated with a full authority digital engine control of each of the gas turbine engines 20 or can be located elsewhere within the aircraft 10. The pilot controls 25 can control multiple aspects of the aircraft 10, such as controlling flight surfaces (e.g., slats/flaps) on wings 12, tail 42, and rudder 50 of the aircraft 10. The pilot controls 25 can transmit commands and receive status from components of the aircraft 10, including the controllers 30, flight management system 40, and other such components. The pilot controls 25 and/or the flight management system 40 can also communicate with offboard systems 70, for instance, using wireless/radio frequency transmission. The offboard systems 70 may provide status information associated with runways, taxiways, weather conditions, and other such information to assist with navigating the aircraft 10 to/from a target location 75, such as a gate of an airport.

The pilot controls 25 can provide manual control interfaces for features such as deployment of the thrust reversers 32 and/or use of the brakes 62. In embodiments of the disclosure, the control system 15 is configured to automatically control deployment of the thrust reversers 32 and/or use of the brakes 62 using the processes as further disclosed herein. The automated control can be managed by either or both of the controllers 30 and/or by the flight management system 40. Automating control of the thrust reversers 32 and braking of the wheels 60 of the aircraft 10 can reduce pilot/co-pilot burdens and operate in combination to reduce component wear. For example, controlling when to deploy or stow the thrust reversers 32 in view of parameters, such as speed of the aircraft 10, corrected aircraft weight, corrected runway length, and other such factors can reduce wear on the brakes 62. Controlling the brake pressure applied and timing of brake pressure application can reduce the rate at which the brakes 62 and associated components may need servicing and/or replacement. Observing parameters such as temperature, precipitation, and weight adjustment of the aircraft 10 as fuel is consumed, the control system 15 can optimize operation of the thrust reversers 32 and brakes 62 for current conditions.

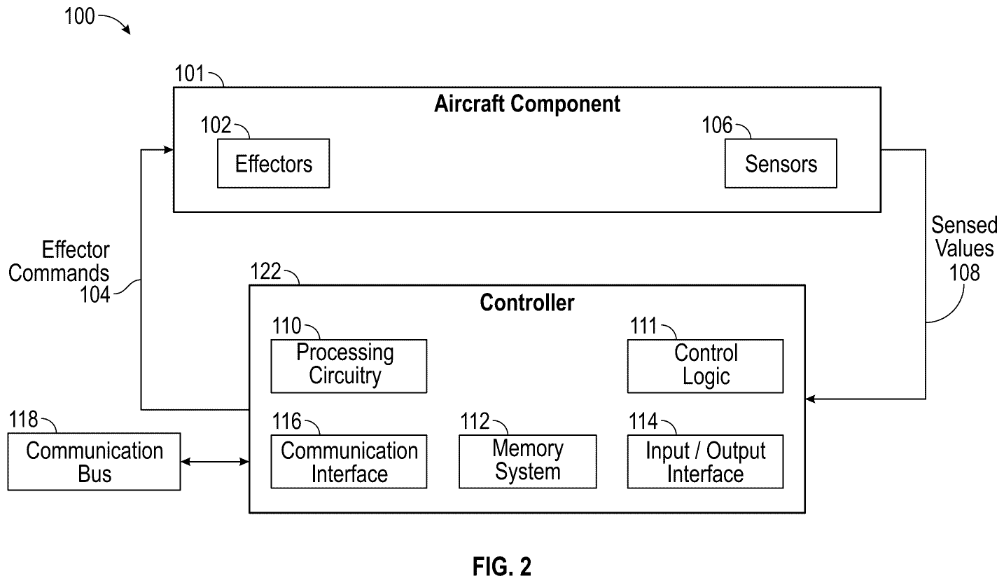

FIG. 2 illustrates a control system 100 as an example of a portion of the control system 15 of FIG. 1 to control one or more aircraft components 101 of the aircraft 10 of FIG. 1. Aircraft components 101 can include subsystems of the aircraft 10, such as one or more gas turbine engines 20, control surfaces of the wings 12, tail 42, rudder 50, and other such components of the aircraft 10 of FIG. 1. The aircraft component 101 can be controlled through adjusting one or more effectors 102 by one or more effector commands 104 output from a controller 122. The controller 122 is an example of one of the controllers 30 of FIG. 1 and can be implemented as dedicated or distributed controls. Examples of effectors 102 can include one or more motors, solenoids, valves, relays, pumps, heaters, and/or other such actuation control components. A plurality of sensors 106 can capture state data associated with the aircraft component 101 and provide sensed values 108 as feedback to the controller 122 to enable closed-loop control according to one or more control laws. Examples of the sensors 106 can include one or more temperature sensors, pressure sensors, strain gauges, switches, position sensors, speed sensors, accelerometers, lube sensors, and the like. As one example, the controller 122 can be a full authority digital engine control. As another example, the controller 122 can include a thrust reverser control, a brake control, or another type of control of the aircraft 10.

The controller 122 can include processing circuitry 110 and a memory system 112 configured to store a plurality of configuration items, where at least one of the configuration items includes a sequence of the computer executable instructions for execution by the processing circuitry 110. Other types of configuration items can include but are not limited to data, such as constants, configurable data, and/or fault data. Examples of computer executable instructions can include boot software, operating system software, and/or application software. The executable instructions may be stored or organized in any manner and at any level of abstraction, such as in connection with controlling and/or monitoring operation of the aircraft component 101. The processing circuitry 110 can be any type or combination of central processing unit (CPU), including one or more of: a microprocessor, a digital signal processor (DSP), a microcontroller, an application specific integrated circuit (ASIC), a field programmable gate array (FPGA), or the like. Also, in embodiments, the memory system 112 may include volatile memory, such as random access memory (RAM), and non-volatile memory, such as Flash memory, read only memory (ROM), and/or other electronic, optical, magnetic, or any other computer readable medium onto which is stored data and algorithms in a non-transitory form.

The controller 122 can also include one or more of an input/output interface 114, a communication interface 116, and/or other elements (not depicted). The input/output interface 114 can include support circuitry for interfacing with the effectors 102 and sensors 106, such as filters, amplifiers, digital-to-analog converters, analog-to-digital converters, and other such circuits to support digital and/or analog interfaces. Further, the input/output interface 114 can receive or output signals to/from other sources. The communication interface 116 can be communicatively coupled to other controllers and/or systems through a communication bus 118. For example, the communication bus 118 can interface with the pilot controls 25 and/or flight management system 40 of FIG. 1. The communication bus 118 may receive and provide aircraft-level parameters and commands that are used by the controller 122 to control the aircraft component 101 in real-time.

The controller 122 can be an aircraft-level control or be distributed between one or more systems of the aircraft 10 of FIG. 1. For example, the controller 122 can be implemented within the flight management system 40 of FIG. 1 or integrated with other such systems of the aircraft 10. Control logic 111 of the controller 122 can be implemented in a combination of circuits and/or executable instructions for execution by the processing circuitry 110 to control effectors 102, for instance, based on various modes, parameters, and models. Control laws implemented by the control logic 111 can be selected and executed depending on whether the aircraft 10 is in a pre-takeoff taxi, takeoff, climb, cruise, descent, landing, or post-landing taxi mode, or other such operating modes, for example. Other special case modes of operation can be entered into based on failure conditions, for instance, to reject a takeoff attempt. The operating mode can be determined based on tracking various parameters, such as weight-on-wheels, altitude, velocity, and other such aircraft parameters. In embodiments, the controller 122 may receive or generate a braking command indicating that the aircraft 10 is to be slowed using the brakes 62 of FIG. 1. The controller 122 may receive or generate a thrust reverser command indicating a request to deploy or stow the thrust reversers 32 of FIG. 1.

The controller 122 can apply control laws and access/update models to determine how to control a combination of aircraft components 101, such as controlling the thrust reversers 32 in combination with the brakes 62. For example, sensed and/or derived parameters related to speed, flow rate, pressure ratios, temperature, thrust, and the like can be used to establish operational schedules and limits to maintain efficient operation of the gas turbine engines 20 and other components of the aircraft 10 of FIG. 1. For instance, the operating mode of the gas turbine engines 20 can have different power settings, thrust requirements, flow requirements, and temperature effects. With respect to the gas turbine engines 20, the thrust output can be increased once the thrust reversers 32 are deployed to increase the reversing effect. Once the aircraft 10 slows below a threshold speed, the gas turbine engines 20 can reduce thrust output back to idle, and the thrust reversers 32 can be commanded to a stowed position, for instance, as commanded by controller 122 or another control of the control system 100. From a pilot's perspective, the control of the brakes 62 and thrust reversers 32 can be automated through the control system 100, reducing the manual control burden and providing consistently repeatable performance. The controller 122 can use optimizing control logic within the control logic 111 to apply weights to parameters to blend the impact of multiple aspects that can add to or reduce the braking capability of the aircraft 10 under current or predicted conditions.

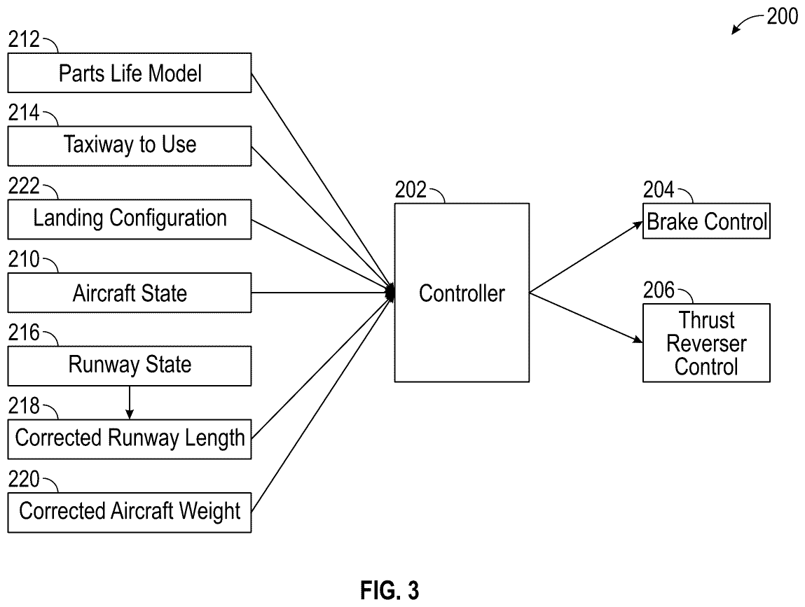

FIG. 3 is a data flow diagram 200 of a controller 202 controlling aspects of a brake control 204 and a thrust reverser control 206. The controller 202 can be implemented as part of the control system 15 of FIG. 1 and/or control system 100 of FIG. 2. For example, the controller 202 can be implemented in one or more of the controllers 30, flight management system 40, controller 122, and/or other such controllers. The brake control 204 is configured to control operation of one or more brakes 62 of the aircraft 10 of FIG. 1. For instance, the brake control 204 can control a brake pressure to reduce the rotational speed of wheels 60 of the aircraft 10. The brake control 204 may also provide feedback to the controller 202 indicating a sensed pressure, temperature, faults and/or other such information as part of an aircraft state 210. The thrust reverser control 206 can be configured to control deployment of one or more thrust reversers 32 of the aircraft 10. For example, the thrust reverser control 206 can control one or more actuators to redirect thrust out of the gas turbine engines 20 of FIG. 1. The thrust reverser control 206 can provide feedback such as thrust reverser door position, actuator position, faults and/or other such information as part of an aircraft state 210.

To determine when to command the brake control 204 and/or thrust reverser control 206, the controller 202 can use a variety of inputs. For example, a parts life model 212 can track and predict the life of various components, such as the brakes 62 of FIG. 1, to determine how the components will be impacted in response to various use cases and environments. The parts life model 212 can be implemented within the controller 202 or provided from another source. Some parameters can be received from external sources (e.g., offboard systems 70 of FIG. 1), such as data regarding the taxiway to use 214 and runway state 216 of a designated runway for use at the target location 75 of FIG. 1. The taxiway to use 214 may include parameters such as length, obstructions present, and other such information. The runway state 216 may indicate if wet, icy, snowy, or clear conditions exist at a targeted runway of the target location 75. Runway state 216 can be used to compute a corrected runway length 218, for instance, by modifying an available runway length parameter when stopping distances are expected to be impacted by current conditions. A corrected aircraft weight 220 may be computed to account for fuel burn during operation and other such adjustments. A landing configuration 222 can indicate how the aircraft 10 of FIG. 1 is intended to be configured or is currently configured during a landing operation, such as approach angle, speed, and other such parameters. Information such as the aircraft state 210, corrected runway length 218, corrected aircraft weight 220, and/or landing configuration 222 may be provided through other systems/components of the aircraft 10, such as the flight management system 40 of FIG. 1.

The controller 202 can be configured to automate the use of the brake control 204 and the thrust reverser control 206 without requiring a direct command from the pilot through the pilot controls 25 of FIG. 1. Different algorithms can be implemented by the control logic 111 of FIG. 2 for landing mode operation and special operating modes, such as a rejected takeoff.

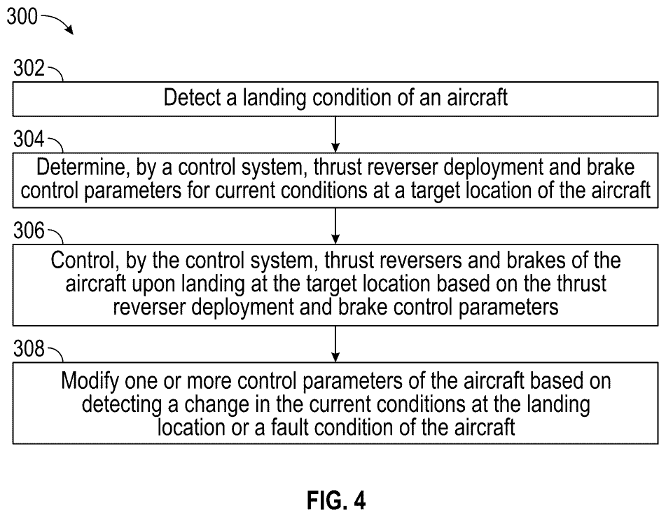

Referring now to FIG. 4 with continued reference to FIGS. 1-3, FIG. 4 is a flow chart illustrating a method 300 for controlling thrust reversers 32 and brakes 62 of aircraft 10 during landing, in accordance with an embodiment. The method 300 may be performed, for example, by the aircraft 10 through the control system 15 of FIG. 1 and/or the control system 100 of FIG. 2. For purposes of explanation, the method 300 is described primarily with respect to the controller 202 of FIG. 3; however, it will be understood that the method 300 can be performed on other configurations.

Method 300 pertains to the controller 202 executing embedded code for braking and thrust control, where the controller 202 can be an aircraft-level control or distributed between aircraft and propulsion system levels of control. At block 302, the controller 202 detects a landing condition of the aircraft 10. The landing condition can be detected based on one or more of: an on-ground state indicator, available runway length, runway condition, aircraft weight, weather condition, throttle setting, and speed of the aircraft 10. For example, weather conditions can include wind speed and direction which may act as a headwind, tailwind, or crosswind. Further, weather conditions, such as rain, ice, sleet, and/or snow can impact stopping ability and the effective length of the runway. Further, extreme hot or cold temperatures can also impact performance of various components of the aircraft 10. The landing condition can also be determined by landing configuration 222 (e.g., flap and slat positions). At block 304, the controller 202 can determine one or more thrust reverser deployment and brake control parameters for one or more current conditions at a target location 75 of the aircraft 10. The controller 202 can be configured to check an operational and/or health state of one or more thrust reversers 32 prior to initiating automated control of the one or more thrust reversers 32.

At block 306, the controller 202 can control one or more thrust reversers 32 and one or more brakes 62 upon landing at the target location 75 based on the one or more thrust reverser deployment and brake control parameters. The controller 202 can be configured to command a gas turbine engine 20 associated with the one or more thrust reversers 32 to increase a thrust output while the one or more thrust reversers 32 are deployed and reduce the thrust output based on the speed of the aircraft 10 dropping below a threshold speed. The controller 202 can be configured to stow the one or more thrust reversers 32 after the speed of the aircraft 10 is below the threshold speed. The controller 202 can be configured to determine the one or more thrust reverser deployment and brake control parameters based at least in part on a parts life model 212 associated with one or more parts of the aircraft 10, a landing configuration 222, and an aircraft state 210. The controller 202 can also be configured to determine the one or more thrust reverser deployment and brake control parameters based at least in part on a corrected runway length 218 at the target location 75 and a corrected aircraft weight 220 of the aircraft 10. The controller 202 can be configured to control a pressure applied on the one or more brakes 62, for instance to reduce part wear and extend the service life of the brakes 62 and/or other parts of the aircraft 10.

At block 308, the controller 202 can modify one or more control parameters of the aircraft 10 based on detecting a change in one or more current conditions at the target location 75 or a fault condition of the aircraft 10. For example, the controller 202 can be configured to limit the thrust output and adjust one or more control surfaces of the aircraft 10 based on detecting a fault with at least one of the one or more thrust reversers 32. The one or more current conditions can include one or more of a runway state 216, a taxiway state, and weather conditions at the target location 75. The controller 202 is configured to determine use of aircraft control surfaces, thrust reverser control, brake control, and engine operation based on a health, state, and the one or more current conditions. An example of a failure accommodation can include controlling the rudder 50 to compensate for an asymmetry if the thrust reverser 32 does not deploy for both of the gas turbine engines 20 when commanded. Limiting the thrust output during thrust reversing can also reduce asymmetric effects if the thrust reverser 32 does not deploy for both of the gas turbine engines 20 when commanded. According to some aspects, the controller 202 can use an optimization function to compare the health and condition of multiple items to determine changes to be made in control parameters. For example, application of various control surfaces, reversers, and engines may depend on the health of these components and suitability of use under current and predicted conditions of the components, the runway, weather conditions, and the like.

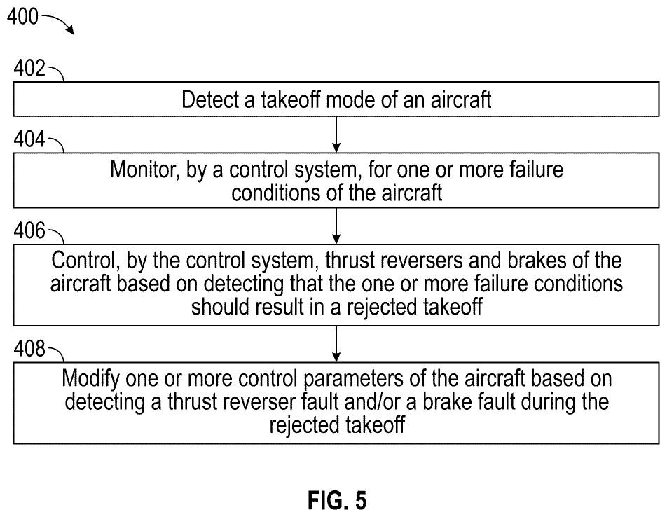

Referring now to FIG. 5 with continued reference to FIGS. 1-4, FIG. 5 is a flow chart illustrating a method 400 for controlling thrust reversers 32 and brakes 62 of aircraft 10 during a rejected takeoff, in accordance with an embodiment. The method 400 may be performed, for example, by the aircraft 10 through the control system 15 of FIG. 1 and/or the control system 100 of FIG. 2. For purposes of explanation, the method 400 is described primarily with respect to the controller 202 of FIG. 3; however, it will be understood that the method 400 can be performed on other configurations.

Method 400 pertains to the controller 202 executing embedded code for braking and thrust control, where the controller 202 can be an aircraft-level control or distributed between aircraft and propulsion system levels of control. At block 402, the controller 202 detects a takeoff mode of the aircraft 10. Takeoff mode can include setting a throttle of the aircraft 10 to a takeoff level. At block 404, the controller 202 monitors for one or more failure conditions of the aircraft 10. Failures detected while there is still sufficient runway length to safely stop the takeoff process can result in a rejected takeoff recommendation.

At block 406, the controller 202 controls one or more thrust reversers 32 and one or more brakes 62 of the aircraft 10 based on detecting that the one or more failure conditions should result in a rejected takeoff. The controller 202 can also output a warning indicator based on detecting that the one or more failure conditions should result in a rejected takeoff. The controller 202 can command a gas turbine engine 20 associated with the one or more thrust reversers 32 to increase a thrust output while the one or more thrust reversers 32 are deployed and reduce the thrust output based on the speed of the aircraft 10 dropping below a threshold speed. The thrust output can be limited and one or more control surfaces of the aircraft 10 can be adjusted based on detecting a fault with at least one of the one or more thrust reversers 32. One or more thrust reverser deployment and brake control parameters can be determined based at least in part on an aircraft state 210, a corrected runway length 218, and a corrected aircraft weight 220 of the aircraft 10.

At block 408, the controller 202 modifies one or more control parameters of the aircraft 10 based on detecting a thrust reverser fault and/or a brake fault during the rejected takeoff. For example, the controller 202 can be configured to limit the thrust output and adjust one or more control surfaces of the aircraft 10 based on detecting a fault with at least one of the one or more thrust reversers 32. The one or more current conditions can include one or more of a runway state 216 and a taxiway state at the target location 75. An example of a failure accommodation can include controlling the rudder 50 to compensate for an asymmetry if the thrust reverser 32 does not deploy for both of the gas turbine engines 20 when commanded. Limiting the thrust output during thrust reversing can also reduce asymmetric effects if the thrust reverser 32 does not deploy for both of the gas turbine engines 20 when commanded.

While the above description has described the flow processes of FIGS. 4 and 5 in a particular order, it should be appreciated that unless otherwise specifically required in the attached claims that the ordering of the steps may be varied. Also, it is clear to one of ordinary skill in the art that, the thrust reverser control and braking described herein can be combined with aircraft and propulsion system control features, such as fuel flow control, power management, emergency operation, and the like.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system of an aircraft, the system comprising:
a thrust reverser control configured to control deployment of one or more thrust reversers of the aircraft;
a brake control configured to control operation of one or more brakes of the aircraft; and
a controller configured to:
detect a landing condition of the aircraft;
determine one or more thrust reverser deployment and brake control parameters for one or more current conditions at a target location of the aircraft;
control the one or more thrust reversers and the one or more brakes upon landing at the target location based on the one or more thrust reverser deployment and brake control parameters; and
modify one or more control parameters of the aircraft based on detecting a change in the one or more current conditions at the target location or a fault condition of the aircraft.

2. The system of claim 1, wherein the landing condition is detected based on one or more of: an on-ground state indicator, available runway length, runway condition, aircraft weight, weather condition, throttle setting, and speed of the aircraft.

3. The system of claim 1, wherein the controller is configured to check an operational and/or health state of the one or more thrust reversers prior to initiating automated control of the one or more thrust reversers.

4. The system of claim 1, wherein the controller is configured to command a gas turbine engine associated with the one or more thrust reversers to increase a thrust output while the one or more thrust reversers are deployed and reduce the thrust output based on the speed of the aircraft dropping below a threshold speed.

5. The system of claim 4, wherein the controller is configured to stow the one or more thrust reversers after the speed of the aircraft is below the threshold speed.

6. The system of claim 4, wherein the controller is configured to limit the thrust output and adjust one or more control surfaces of the aircraft based on detecting a fault with at least one of the one or more thrust reversers.

7. The system of claim 1, wherein the one or more current conditions comprise one or more of a runway state, a taxiway state, and weather conditions at the target location, and the controller is configured to determine use of aircraft control surfaces, thrust reverser control, brake control, and engine operation based on a health, state, and the one or more current conditions.

8. The system of claim 1, wherein the controller is configured to determine the one or more thrust reverser deployment and brake control parameters based at least in part on a parts life model associated with one or more parts of the aircraft, a landing configuration, and an aircraft state.

9. The system of claim 8, wherein the controller is configured to determine the one or more thrust reverser deployment and brake control parameters based at least in part on a corrected runway length at the target location and a corrected aircraft weight.

10. The system of claim 1, wherein the controller is configured to control a pressure applied on the one or more brakes.

11. A method comprising:
detecting, by a control system of an aircraft, a landing condition of the aircraft;
determining, by the control system, one or more thrust reverser deployment and brake control parameters for one or more current conditions at a target location of the aircraft;
controlling, by the control system, the one or more thrust reversers and the one or more brakes upon landing at the target location based on the one or more thrust reverser deployment and brake control parameters; and
modifying, by the control system, one or more control parameters of the aircraft based on detecting a change in the one or more current conditions at the target location or a fault condition of the aircraft.

12. The method of claim 11, wherein the landing condition is detected based on one or more of: an on-ground state indicator, available runway length, runway condition, aircraft weight, weather condition, throttle setting, and speed of the aircraft.

13. The method of claim 11, further comprising:
commanding, by the control system, a gas turbine engine associated with the one or more thrust reversers to increase a thrust output while the one or more thrust reversers are deployed and reduce the thrust output based on the speed of the aircraft dropping below a threshold speed; and
stowing the one or more thrust reversers after the speed of the aircraft is below the threshold speed.

14. The method of claim 11, wherein the one or more current conditions comprise one or more of a runway state and a taxiway state at the target location, and further comprising:
determining the one or more thrust reverser deployment and brake control parameters based at least in part on a parts life model associated with one or more parts of the aircraft, a landing configuration, an aircraft state, a corrected runway length at the target location and a corrected aircraft weight.

15. The method of claim 11, further comprising:
controlling a pressure applied on the one or more brakes.

16. A method comprising:
detecting, by a control system of an aircraft, a takeoff mode of the aircraft;
monitoring, by the control system, for one or more failure conditions of the aircraft;
controlling, by the control system, one or more thrust reversers and one or more brakes of the aircraft based on detecting that the one or more failure conditions should result in a rejected takeoff; and
modifying, by the control system, one or more control parameters of the aircraft based on detecting a thrust reverser fault and/or a brake fault during the rejected takeoff.

17. The method of claim 16, further comprising:
outputting a warning indicator based on detecting that the one or more failure conditions should result in a rejected takeoff.

18. The method of claim 16, further comprising:
commanding, by the control system, a gas turbine engine associated with the one or more thrust reversers to increase a thrust output while the one or more thrust reversers are deployed and reduce the thrust output based on the speed of the aircraft dropping below a threshold speed.

19. The method of claim 18, further comprising:
limiting the thrust output and adjusting one or more control surfaces of the aircraft based on detecting a fault with at least one of the one or more thrust reversers.

20. The method of claim 16, further comprising:
determining the one or more thrust reverser deployment and brake control parameters based at least in part on an aircraft state, a corrected runway length, and a corrected aircraft weight.
